(19) United States
(12) Patent Application Publication
(10) Pub. No.: US 2010/0243882 A1
(43) Pub. Date: Sep. 30, 2010

(54) HEATED OPTICAL COMPONENTS

(75) Inventor: William Loyd, Sugar Land, TX (US)

Correspondence Address: RAUSCHENBACH PATENT LAW GROUP, LLP, P.O. BOX 387, BEDFORD, MA, 01730, US

(73) Assignee: DH TECHNOLOGIES DEVELOPMENT PTE. LTD., UOB Plaza (SG)

(21) Appl. No.: 12/732,442

(22) Filed: Mar. 26, 2010

Related U.S. Application Data
(60) Provisional application No. 61/164,137, filed on Mar. 27, 2009.

(51) Int. Cl. B01D 59/44; G02B 7/00

(52) U.S. Cl. 250/282; 359/512

(57) ABSTRACT

Applicant's teachings relate to apparatuses and methods of cleaning laser optical components, particularly in, for example, but not limited to, high throughput matrix-assisted laser desorption ionization (MALDI) applications. In accordance with various embodiments of applicant's teachings, the optical component is heated.

### CROSS REFERENCE TO RELATED APPLICATIONS

This patent application claims priority to U.S. Provisional Patent Application Ser. No. 61/164,137, filed on Mar. 27, 2009, the entire disclosure of these patent applications are incorporated herein by reference.

### FIELD

Applicant's teachings relate to apparatuses and methods of cleaning laser optical components, particularly in matrix-assisted laser desorption ionization (MALDI) applications.

### INTRODUCTION

Generally, with analytical instruments using laser desorption as the ionization mechanism, such as, for example, in a matrix-assisted-laser-desorption-ionization (MALDI) mass spectrometer, the laser is often located remotely from the sample target. This accommodates the environmental operating conditions of the mass spectrometer, which can include, for example, vacuum conditions.

Various conventional light transmission methods can be used to guide the light from the laser to the sample while maintaining the physical separation between the sample and the laser. Some of these methods can include, for example, but not limited to, positioning optical components, such as mirrors and focus lenses for controlling the beam size between the laser and the sample. The mirrors reflect the laser light to the sample. With known MALDI sources, however, the laser light hits the sample and forms a plume of debris, or vaporized mixture of sample, matrix material and sample ions. The plume expands outwardly from the source and can follow the path taken by the laser. Since some of the optical components, such as, for example, but not limited to, the laser mirror, lie in the path of the expanding plume, the surface of these components can become contaminated. The cleaning of the mirror can be inconvenient and can result in an interruption of workflow. Specifically, mechanical cleaning can involve significant instrument downtime resulting in reduction of sample throughput.

### SUMMARY

Applicant's teachings relate to apparatuses and methods of cleaning laser optical components, particularly in, for example, but not limited to, matrix-assisted laser desorption ionization (MALDI) applications. In accordance with various embodiments of applicant's teachings, a method for reducing contaminant accumulation on an optical component for use with a laser in laser desorption ionization is disclosed. The method comprises heating the optical component. In accordance with various embodiments of the applicant's teachings, the optical component is heated in high throughput laser desorption applications, for example, but not limited to, high throughput MALDI mass spectrometry. It is generally desirable to increase the rate of analysis (throughput rate) so that more samples can be analyzed in a given time period. For example, one method of performing high throughput MALDI mass spectrometry is to employ a high repetition rate laser where high frequencies of laser pulses generate very intense and stable ion signals that are sufficient for fast sample analysis. Such a high repetition rate laser, however, has the potential of generating greater amounts of vaporized debris in the plume, which increases the contamination of the surface of the optical components generally in the path of the plume. High throughput MALDI mass spectrometry can have lasers running up to 1000 Hz, or higher, for example, but not limited to, in some embodiments of applicant's teachings, as high as 5 kHz. In these applications, the optical components can reveal a contamination spot after running continuously for only one (1) week.

In accordance with some embodiments of applicant's teachings, the optical component is heated by operably coupling a heater to the optical component. The heater can be a resistive heater.

In accordance with various embodiments of applicant's teachings, the optical component is heated while the laser is used in laser desorption ionization, so that the heating of the optical component prevents or minimizes the accumulation of debris on the optical component.

In accordance with some embodiments of applicant's teachings, the optical component is heated to a temperature of about 60-75° C.

In accordance with various embodiments of applicant's teachings, the optical component is heated by increasing the laser power. In accordance with some embodiments of applicant's teachings, the method can comprise after using the laser for laser desorption ionization, increasing the laser power so that the laser cleans the optical component of accumulated debris. The laser power can be increased to about 30-60 μJ. Moreover, the laser power can be increased for a period of time of about 2-60 minutes, as required.

In accordance with various embodiments of applicant's teachings, it can be appreciated that the optical component can be a mirror or a lens that is contaminated by debris from the high throughput application.

Further, in accordance with various embodiments of applicant's teachings an optical component assembly for use with a laser in laser desorption ionization is provided. The assembly includes a support, an optical component coupled to the support, and a heater. The heater can be operatively coupled to the optical component so that the heater heats the optical component to reduce the accumulation of debris on the optical component.

Further, in accordance with some embodiments of applicant's teachings a sensor can be operatively coupled to the optical component, so that the sensor monitors the temperature of the optical component.

Moreover, in accordance with various embodiments of applicant's teachings, three support surfaces are provided on the support to support the optical component. Further, the optical component is coupled to the support by a holder, the holder having a retaining portion thereof spaced from the support surfaces, so that at least part of the optical component is retained between the retaining portion of the holder and the support surfaces. Further the retaining portion of the holder contacts the optical component over at least two opposing edges of the optical component. Moreover, the holder is a plurality of holders with each one having a retaining portion. In accordance with some embodiments of applicant's teachings at least three retaining portions are provided to contact the other face of the optical component, the three retaining portions provided over two opposing edges of the optical component. The holder can be made of a heat resistant material.

In accordance with various embodiments of applicant's teachings the holder includes a clamp to secure the holder to the support. The clamp can be made of a heat resistant material, such as, for example, but not limited to, a fluoropolymer or a poly(tetrafluoroethylene) or poly(tetrafluoroethene).

In accordance with various embodiments of applicant's teachings, the optical component can be retained so that one face of the optical component contacts the support surfaces, and at least a portion of the other face of the optical component is contacted by the retaining portion of the holder. Moreover, the support can have a recessed portion adapted to receive the optical component.

Further, in accordance with various embodiments of applicant's teachings, the heater is positioned between one surface of the optical component and the support.

In accordance with some embodiments of applicant's teachings, the heater can be a resistive heater.

Further, in accordance with some embodiments of applicant's teachings the sensor can be positioned between the one surface of the optical component and the support, the sensor spaced from the heater.

### DRAWINGS

The skilled person in the art will understand that the drawings, described below, are for illustration purposes only. The drawings are not intended to limit the scope of the applicant's teachings in any way.

FIG. 1 is a schematic of sample optic components used in laser desorption ionization;

FIG. 2 are photographs showing an example mirror of the optical components, the mirror contaminated with matrix sample;

FIG. 3 are photographs showing an example mirror cleaned in accordance with some embodiments of Applicant's teachings;

FIG. 4 is a perspective view of an optical component assembly according to some embodiments of Applicant's teaching;

FIG. 5 is an exploded view of the assembly shown in FIG. 4;

FIG. 6 is a perspective view of the assembly of FIG. 4 in an ion source assembly; and

FIG. 7 is a schematic of sample optic components used in laser desorption ionization according to various embodiments of applicant's teachings.

### DESCRIPTION OF VARIOUS EMBODIMENTS

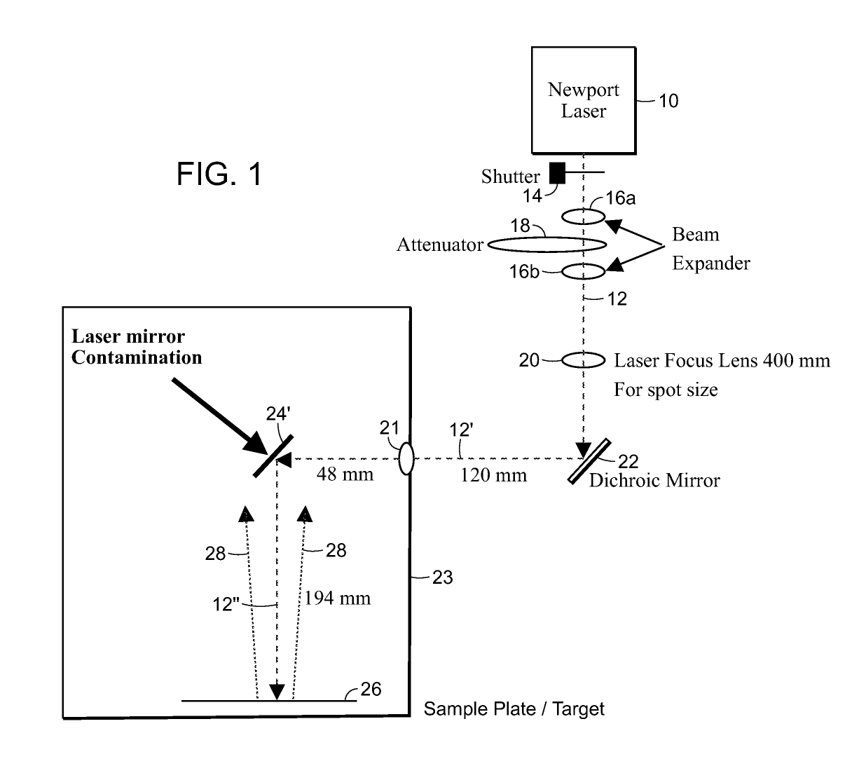

FIG. 1 is a schematic of an example of the optic components using laser desorption as the ionization mechanism, such as, for example, but not limited to, in a matrix-assisted-laser-desorption-ionization (MALDI) mass spectrometer. For the example illustrated a laser 10 passes a beam 12 through various optic components, including a shutter 14, beam expander lenses 16a and 16b, attenuator 18, and lens 20. In some embodiments of applicant's teachings the beam 12 is deflected by a dichroic mirror 22 to form beam 12′. Beam 12′ is directed through a view port 21 of a chamber 23 that holds a sample plate 26. Chamber 23 in various embodiments of applicant's teachings is at or near a vacuum.

After beam 12′ enters chamber 23 through view port 21, it is deflected by a mirror 24 to form beam 12″. Beam 12″ is thereby directed to the sample plate 26. When the laser beam 12″ hits the sample on the sample plate 26, a plume 28 of debris, or vaporized material, can be generated. For example, with MALDI sources, the plume 28 that defines the debris can be a mixture of sample, matrix material and sample ions, but also can comprise, for example, but not limited to, salts and tissue membranes. The plume 28 expands outwardly and can follow back along the path that the laser light had taken, i.e., beam 12″. Since some of the optical components, such as, for example, but not limited to, the mirror 24, lie in the path of the expanding plume, the surface of these components can become contaminated with debris from the plume.

The plume 28 of vaporized material tends to dissipate or lose momentum as a function of distance. Accordingly, an optical component, such as, for example, but not limited to, a mirror 24 mounted sufficiently far from the sample plate 26 will generally be less contaminated than a mirror positioned closer to the sample plate. However, the mirrors set distance is generally determined by instrument design and physical constraints. The mirror 24 can be, for example, but not limited to, 194 mm away from the sample plate 26.

Further, it is generally desirable to increase the rate of analysis (throughput rate) so that more samples can be analyzed in a given time period. For example, one method of performing high throughput MALDI mass spectrometry is to employ a high repetition rate laser where high frequencies of laser pulses generate very intense and stable ion signals that are sufficient for fast sample analysis. Such a high repetition rate laser, however, has the potential of generating greater amounts of vaporized debris in the plume 28, which increases the contamination to the surface of the optical components, for example, the surface of mirror 24. For example, typical use running the laser at 200 Hz. can result in contamination of the mirror about every 12-18 months of heavy use. But high throughput MALDI mass spectrometry having lasers running up to 1000 Hz. can reveal a contamination spot on the laser mirror after running continuously for only one (1) week.

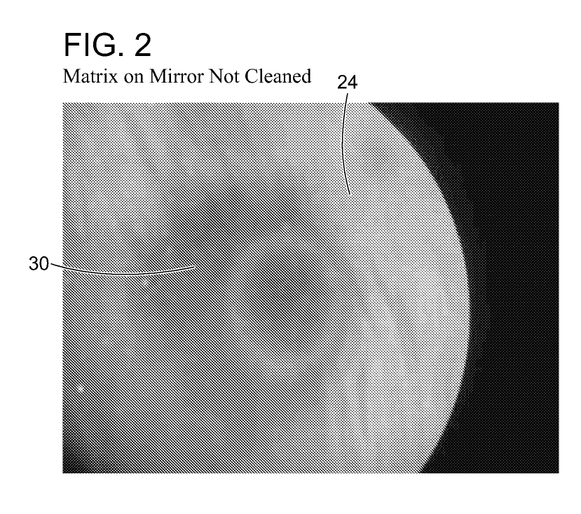

FIG. 2 shows a photograph of mirror 24 contaminated with matrix at 30. Contaminated mirror 24 as shown in FIG. 2 has no visible surface useful for laser reflection. Further, mirror 24 is useful in visualizing sample 26 when viewing through view port 21, so contamination reduces the usefulness of mirror 21 for this purpose.

Accordingly, with high throughput analysis operations, the optical components would require periodic cleaning to maintain performance. Cleaning of mirror 24, for example, involves shutting down the instrument and wiping the surface. For example, the mirror 24 can be wiped with methanol or any organic solvent soluble to the matrix. To fully clean the mirror without damaging the surface, it is found that using an acetone and a KimWipe™ can be effective.

In accordance with various embodiments of Applicant's teaching heating the mirror can reduce contaminant accumulation on mirror 24. In accordance with some embodiments of applicant's teachings, the mirror 24 is heated by increasing the power of the laser 10. For example, the laser 10 is used in a laser desorption ionization application, such as, for example, (MALDI). After a period of use, the laser power is increased so that the laser 10 heats and thereby cleans the mirror 24 of the accumulated debris. For example, but not limited to, in some embodiments of applicant's teachings, the period of use can be determined by the loss of sensitivity of the ion source in general, i.e., the full laser power is no longer being transmitted and deflected by the optics to the sample plate 26. For example, and as discussed in more detail in Applicant's co-pending patent application, Attorney Reference No. 571-1106, the entire contents of which are hereby incorporated by reference, the cleaning of the mirror by increasing the laser power can be timed to coincide with the bake-out process performed on the ion optics of the mass spectrometer. For example, but not limited to, when a performance loss by the instrument is detected beyond a set threshold, or as a scheduled event after a predetermined number of samples have been analyzed. In some embodiments, the period can be substantially equal to a week. In other embodiments, the period can be substantially equal to five (5) days. In some other embodiments, the period is measured in terms of the number of samples processed rather than the time elapsed between the first and last samples. In various embodiments in which the bake-out times of the ion optics are determined by performance loss, the set threshold can be 50% of peak performance. It is understood that in other embodiments the performance threshold can be set to other values other than 50% of peak performance.

In accordance with some embodiments of Applicant's teaching, the laser power is increased to, for example, but not limited to, about 60 μJ to heat and clean the optical components, such as, for example, but not limited to, mirror 24. The laser power can be increased to this level for a period of about 10 minutes. It can be appreciated, however, that the invention is not limited to only about 60 μJ and only about 10 minutes. For example, but not limited to, about 30 μJ could be used to heat and clean the mirror for longer running periods. Further, shorter running periods of a few minutes might be possible with increased laser power.

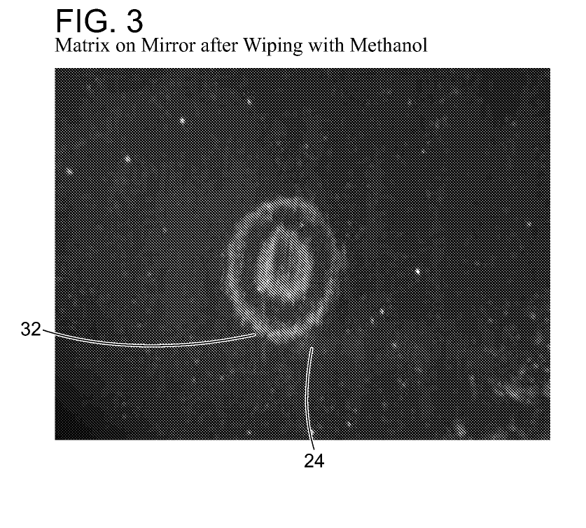

FIG. 3 shows photographs of mirror 24 cleaned by laser 10. A white matrix ring 32 can remain on mirror 24, but the matrix ring 32 does not affect the area of reflection of mirror 24 cleaned by the laser 10.

In accordance with various embodiments of Applicant's teachings, the optical components, such as, for example, but not limited to, a mirror 24, can be heated to reduce contaminant accumulation by operably coupling a heater to the optical component. In these embodiments, the optical component can be heated while the laser is used in laser desorption ionization, so that the heating of the optical component prevents or minimizes the accumulation of debris on the component during use. In accordance with some embodiments of Applicant's teachings the optical component can be heated to a temperature of about 60-75° C., during operation of the instrument.

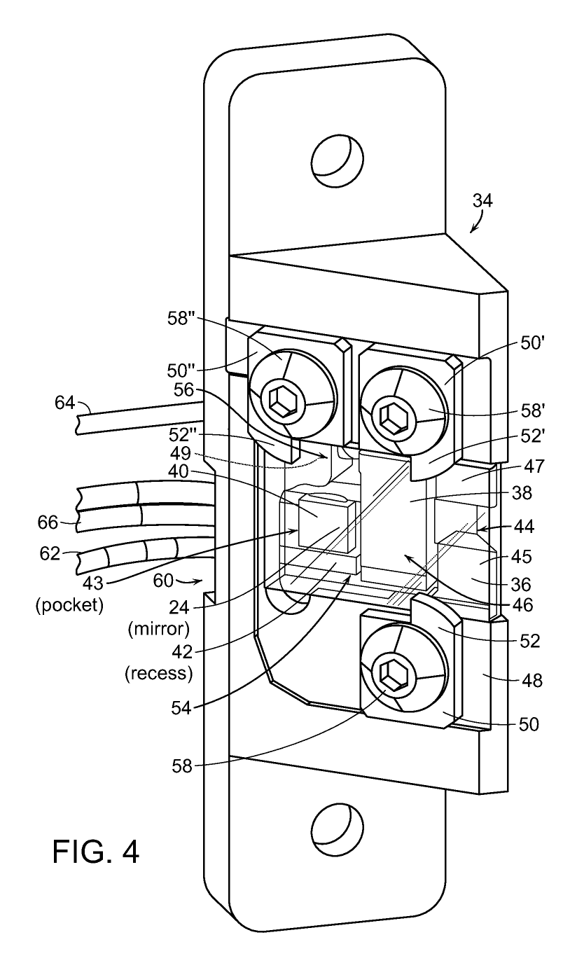

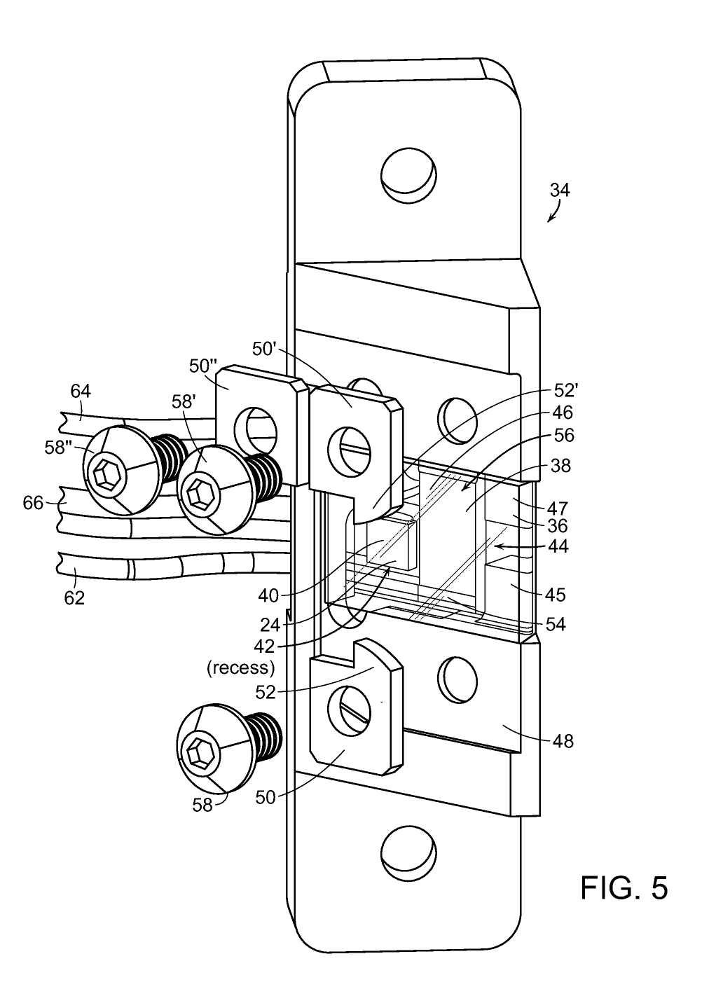

Referring to FIGS. 4 and 5, various embodiments of applicant's teachings showing a heated optical component assembly 34 is shown. For example, but not limited to, assembly 34 can be used to heat optical mirror 24 for use with a laser in laser desorption ionization. The assembly 34 comprises a support 36, mirror 24 coupled to the support 36 and a heater 38 to heat the mirror 24 and thereby reduce the accumulation of debris on the mirror. The heater 38 is operatively coupled to the mirror 24 to transfer heat to the mirror. The heater 38 can be, in accordance with some embodiments of applicant's teachings, a surface mount resistor similar to that used in printed circuit board applications. Other types of heaters are contemplated, however, such as, for example, but not limited to, resistive materials that generate heat when a current is applied, and high power LEDs that can transfer (radiate) heat to the optical component. Moreover, more than one heater can be provided.

In accordance with some embodiments of applicant's teachings, assembly 34 also includes a sensor 40. The sensor 40 can be spaced from the heater 38. The sensor 40 is operatively coupled to the mirror 24, so that the sensor 40 can monitor the temperature of the mirror 24. The sensor 40 is connected to a control unit (not shown) that adjusts the temperature of the heater 38 and thereby the mirror 24 in response to the temperature sensed.

In accordance with some embodiments of applicant's teachings, the support 36 has a recessed portion 42. Recess 42 is adapted, that is of a shape and configuration, to receive at least a portion of the mirror 24. In particular, the mirror 24 is retained so that one face 44 of the mirror 24 contacts or rests on support surfaces 45, 47 and 49 in recessed portion 42. A pocket 43 is machined into the recessed portion 42 of support 36. Pocket 43 is adapted to receive the heater 36 and sensor 40, and the associated wires so that these components are within the recessed portion and do not form part of support for the mirror 24.

In accordance with various embodiments of applicant's teachings slightly the raised surfaces 45, 47 and 49 (see FIG. 4) in recessed portion 42 forms the foundation of the support for the mirror 24. Moreover, raised surfaces 45, 47 and 49 have been designed, in accordance with various embodiments of applicant's teachings where the support 36 is for mirror 24, to hold the mirror at the desired 45° angle in support 36, permitting the beam 12″ to strike the sample plate 26 on axis. By providing three (3) points to support the optical component, the optical component is prevented from bending when being clamped. For example, but not limited to, bending of the mirror 24 can cause imaging problems, since the mirror 24 can be used to visualize the sample plate 26 when viewing through the view port 21. If the mirror bends more than, for example, ¼ of a wavelength, the image can become blurry. When mirror 24 is retained within recessed portion 42 on surfaces 45, 47 and 49 a reflective face 46 of the mirror 24 is presented so as to be generally level with face 48 of support 36 (see FIG. 4).

According to various embodiments of applicant's teachings, a holder couples the optical component to the surfaces 45, 47 and 49 of the recessed portion 42. In some embodiments of applicant's teachings, for example, but not limited to, as illustrated in FIGS. 4 and 5, a plurality of holders 50, 50′ and 50″ is provided, with each holder contacting a separate portion of the optical component to retain the optical component in place. In some embodiments of applicant's teachings, the optical component has a retaining portion, such as, for example, 52, 52′ and 52″, respectively for holders 50, 50′ and 50″. The retaining portion can be spaced from the support surfaces 45, 47 and 49 of the recessed portion 42 so that at least part of the optical component is retained between the retaining portion of the holder and the support surfaces. For example, in accordance with various embodiments of applicant's teachings, and as illustrated in FIGS. 4 and 5, retaining portions 52, 52′ and 52″ are spaced from the support surfaces 45, 47 and 49, respectively, of the recessed portion 42 so that mirror 24 is retained between the respective retaining portions 52, 52′ and 52″ of the holders 50, 50′ and 50″ and the support surfaces 54, 47 and 49.

In accordance with various embodiments of applicant's teachings, the retaining portion 52, 52′ and 52″ of the holder 50, 50′ and 50″ contacts the face 46 of the optical component over at least two opposing edges, 54 and 56, respectively. In various embodiments of applicant's teachings, and as illustrated in FIGS. 4 and 5, three (3) holders are provided, 50, 50′ and 50″, and each holder has a retaining portion 52, 52′ and 52″, respectively, to contact the face 46 of the mirror 24 over the two opposing edges 54 and 56 of the mirror.

Moreover, the retaining portion, such as retaining portions 52, 52′ and 52″ should be so shaped and flexible to substantially prevent the optical component from bending when the optical component is subject to heat (i.e., thermal expansion), and to the clamping force required to secure the optical component in place.

In accordance with some embodiments of applicant's teachings the holders 50, 50′ and 50″ can be made of a heat resistant material, for example, but not limited to, thermally non-conductive materials, such as polymer-type materials like Peek™ or Techtron™. Such materials allow the use of a relatively small heater. Less heat resistant materials, such as, for example, metal or ceramic based materials would conduct the heat from the optical component requiring a larger heater.

In accordance with various embodiments of applicant's teachings the holder can also include a clamp, such as clamps 58, 58′ and 58″, as illustrated in FIGS. 4 and 5, to secure the respective holders 50, 50′ and 50″ to the assembly 34. The clamp can be made of a heat resistant material, such as, for example, but limited to a fluoropolymer, such as poly(tetrafluoroethylene) or poly(tetrafluoroethene), commonly known as Teflon™.

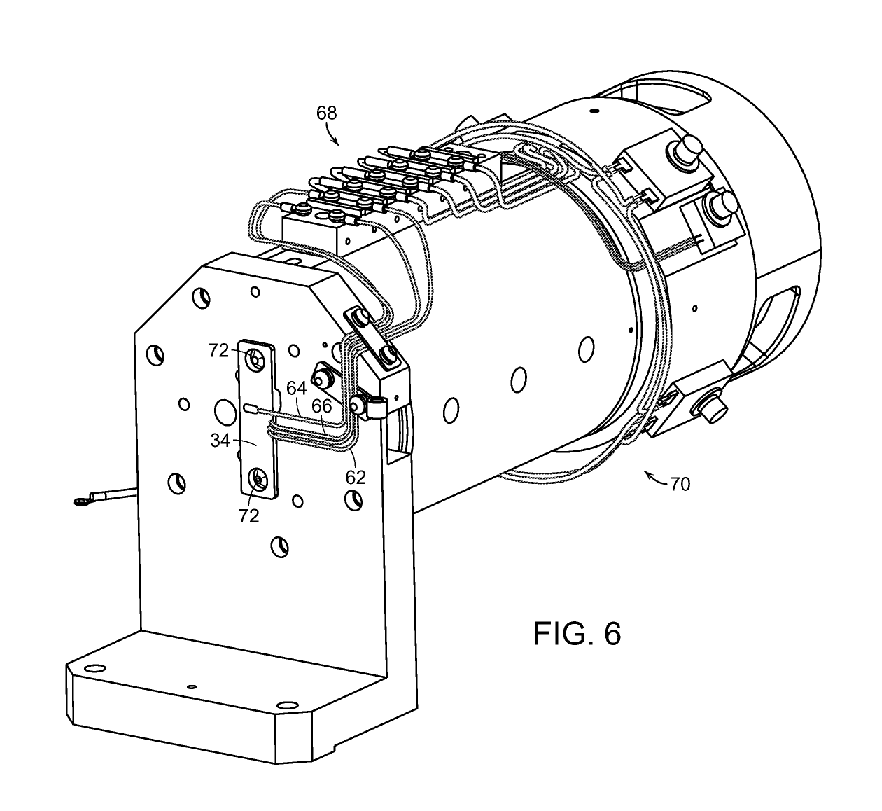

In accordance with various embodiments of applicant's teachings the support 36 is provided with an opening 60 (see FIG. 5) through which the various wires for the heater 38 and sensor 40 can be fed. In particular wires 62 and 64 attach to each side of the resistive heater 38, and wire 66 is attached to the sensor 40. These wires are connected at their respective other ends to a terminal block 68 of the sample source 70 (see FIG. 6), which receives the appropriate control signals to operate the heater and sensor of the assembly 34. FIG. 6 also illustrates assembly 34 connected to the sample source 70, in accordance with some embodiments of applicant's teachings. Assembly 34 can be connected to the source 70 using, for example, but not limited to, suitable threaded fasteners 72.

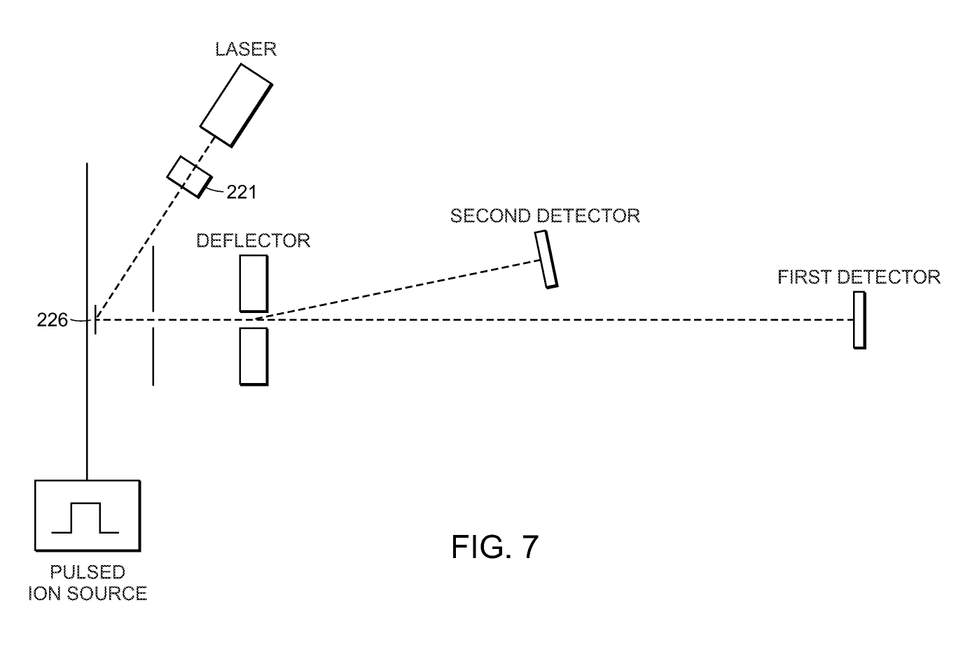

It can also be appreciated that applicant's teachings can be applied to other optical components in the system, particularly in optical components in chamber 23. For example, lens in view port 21, although not generally directly in the line-of-sight of the plume 28, can also become contaminated over many samplings. For example, in some embodiments of applicant's teachings, for example, as shown in FIG. 7, the view port 221 can be at about 30° to the sample plate 226. In these embodiments a heater and sensor can be secured to the lens in view port 221, in accordance with applicant's teachings, to heat the lens of the view port 221 and thereby reduce or eliminate accumulation of debris.

While the applicants' teachings are described in conjunction with various embodiments, it is not intended that the applicants' teachings be limited to such embodiments. On the contrary, the applicants' teachings encompass various alternatives, modifications, and equivalents, as will be appreciated by those of skill in the art.

1. A method for reducing contaminant accumulation on an optical component for use with a laser in laser desorption ionization, the method comprising heating the optical component.

2. The method of claim 1, wherein the optical component is heated in high throughput laser desorption applications.

3. The method of claim 1, wherein the laser desorption application is high throughput MALDI mass spectrometry.

4. The method of claim 1, wherein the optical component is heated by operably coupling a heater to the optical component.

5. The method of claim 4, wherein the heater is a resistive heater.

6. The method of claim 1, wherein the optical component is heated while the laser is used in laser desorption ionization, so that the heating of the optical component prevents or minimizes the accumulation of debris on the optical component.

7. The method of claim 1, wherein the optical component is heated to a temperature of about 60-75° C.

8. The method of claim 1, wherein the optical component is heated by increasing the laser power.

9. The method of claim 8, further comprising:
a) using the laser in laser desorption ionization; and
b) after using the laser for laser desorption ionization, increasing the laser power so that the laser cleans the optical component of accumulated debris.

10. The method of claim 8, wherein the laser power is increased to about 30-60 μJ.

11. The method of claim 8, wherein the laser power is increased for a period of time of about 2-60 minutes.

12. The method of claim 1, wherein the optical component is a lens.

13. The method of claim 1, wherein the optical component is a mirror.

14. An optical component assembly for use with a laser in laser desorption ionization, the assembly comprising:
a support;
an optical component coupled to the support; and
a heater, the heater operatively coupled to the optical component, the heater to heat the optical component to reduce the accumulation of debris on the optical component.

15. The optical component assembly of claim 14, further comprising a sensor operatively coupled to the optical component, the sensor to monitor the temperature of the optical component.

16. The optical component assembly of claim 14, wherein three support surfaces are provided on the support to support the optical component.

17. The optical component assembly of claim 16, wherein the optical component is coupled to the support by a holder, the holder having a retaining portion thereof spaced from the support surfaces, so that at least part of the optical component is retained between the retaining portion of the holder and the support surfaces.

18. The optical component assembly of claim 17, wherein the retaining portion of the holder contacts the other face of the optical component over at least two opposing edges of the optical component.

19. The optical component assembly of claim 17, wherein the holder is a plurality of holders with each one having a retaining portion.

20. The optical component assembly of claim 17, wherein at least three retaining portions are provided to contact the other face of the optical component, the three retaining portions provided over two opposing edges of the optical component.

21. The optical component assembly of claim 17, wherein the holder is made of a heat resistant material.

22. The optical component assembly of claim 17, wherein the holder includes a clamp to secure the holder to the support.

23. The optical component assembly of claim 22, wherein the clamp is made of a heat resistant material.

24. The optical component assembly of claim 23, wherein the clamp is made from a fluoropolymer.

25. The optical component assembly of claim 23, wherein the clamp is made from a poly(tetrafluoroethylene) or poly(tetrafluoroethene).

26. The optical component assembly of claim 17, wherein the optical component is retained so that one face of the optical component contacts support surfaces, and at least a portion of the other face of the optical component is contacted by the retaining portion of the holder.

27. The optical component assembly of claim 14, wherein the support has a recessed portion adapted to receive the optical component.

28. The optical component assembly of claim 14, wherein the heater is positioned between one surface of the optical component and the support.

29. The optical component assembly of claim 28, wherein the heater is a resistive heater.

30. The optical component assembly of claim 28, wherein the sensor is positioned between the one surface of the optical component and the support, the sensor spaced from the heater.

31. The optical component assembly of claim 14, wherein the optical component is a mirror.
